(19) United States
(12) Patent Application Publication
(10) Pub. No.: US 2011/0061803 A1
(43) Pub. Date: Mar. 17, 2011

(54) MANUFACTURING METHOD OF IMAGE DISPLAY APPARATUS, AND BONDING METHOD OF BASE MATERIAL

(75) Inventors: Mitsutoshi Hasegawa, Yokohama-shi (JP); Mamo Matsumoto, Hiratsuka-shi (JP); Tomohiro Saito, Kouza-gun (JP)

(73) Assignee: CANON KABUSHIKI KAISHA, Tokyo (JP)

(21) Appl. No.: 12/875,997

(22) Filed: Sep. 3, 2010

(30) Foreign Application Priority Data
Sep. 14, 2009 (JP) 2009-211714

(51) Int. Cl. B29C 65/14

(52) U.S. Cl. 156/272.2

(57) ABSTRACT

An image display apparatus manufacturing method comprises: arranging a bonding material between a pair of base materials acting as a first or second substrate and a frame member, wherein the bonding material includes a main portion extending along the frame member in a closed shape, and a thinner additional portion branching from the main portion as an elongation of a side constituting the main portion; and bonding, as mutually pressing to each other the base materials, the pair of the base materials by the bonding material, by irradiating an electromagnetic wave to the main portion while moving an irradiation position along the bonding material to melt the main portion, and then hardening the melted main portion. Thus, a crack having a possibility of occurrence and widening from the corners of the bonding material can be easily suppressed.

### BACKGROUND OF THE INVENTION

1. Field of the Invention

The present invention relates to a manufacturing method of an image display apparatus and a bonding method of a base material, and more particularly to a bonding method of members constituting an envelope of the image display apparatus.

2. Description of the Related Art

There is known a method of, in a manufacturing process of an image display apparatus, interposing a bonding material between a pair of base materials, melting the bonding material by irradiating an electromagnetic wave such as a laser beam or the like to the bonding material, and thus bonding the pair of the base materials together. Here, Japanese Patent Application Laid-Open (Translation of PCT Application) 2008-517446 discloses a method of airtightly sealing up a cover plate and a substrate, by taking an organic light emitting diode display for example. In this method, a bonding material (frit) is previously applied in an appropriate way to the cover plate like a frame, that is, substantially like a square in the example, and the cover plate is baked to burn out an organic binder included in the bonding material. After then, a laser beam is irradiated to the bonding material as lightly pressing the cover plate on which the bonding material has been formed and the substrate to each other, and the bonding material is thus melted, whereby the cover plate and the substrate are airtightly sealed up.

If the bonding material is heated and thus melted, the base material being in contact with the bonding material is accordingly heated and thermally expanded. When the bonding material is in a melting state, it is flowable. Thus, even if the base material is deformed due to the thermal expansion, the base material is not held by the bonding material because the bonding material is deformed substantially in conformity with the deformation of the base material. However, if the bonding material is cooled down and thus hardened, the base material is held by the bonding material due to a difference between a thermal contraction amount of the bonding material and a thermal contraction amount of the base material. Since a temperature of the bonding material tends to rise in general as compared with the base material, the thermal contraction amount of the bonding material becomes larger when similar materials are used respectively for the bonding material and the base material. For this reason, shearing force due to the thermal contraction of the bonding material is applied to the base material. When the shearing force like this is applied, crack occurs easily in the base material particularly based on positions of four corners of the bonding material.

### SUMMARY OF THE INVENTION

The present invention aims to provide a manufacturing method of an image display apparatus and a bonding method of base materials, in which a stress applied from the bonding material to the base material due to heating and cooling of the bonding material can be easily reduced and crack having a possibility of occurrence and widening from corners of the bonding material can be easily suppressed.

The present invention is characterized by a manufacturing method of an image display apparatus which comprises a first substrate having numerous electron-emitting devices, a second substrate positioned opposite to the first substrate and having a fluorescent film of displaying an image in response to irradiation of electrons emitted from the electron-emitting devices, and a frame member positioned between the first substrate and the second substrate to form a space between the first substrate and the second substrate, the method comprising: arranging a bonding material between a pair of base materials acting as the first substrate and the frame member or acting as the second substrate and the frame member, wherein the bonding material includes a main portion extending along one of the base materials acting as the frame member in a closed shape, and an additional portion, thinner than the main portion, branching from the main portion as an elongation of a side constituting the main portion; and bonding, as mutually pressing to each other the base materials of the pair of the base materials, the pair of the base materials by the bonding material, by irradiating an electromagnetic wave to the main portion of the bonding material while moving an irradiation position along the bonding material to melt the main portion of the bonding material, and then hardening the melted main portion of the bonding material.

Further, the present invention is characterized by a base material bonding method comprising: arranging, between a pair of base materials including a flat plate and a frame member, a bonding material which includes a main portion extending along the frame member in a closed shape, and an additional portion, thinner than the main portion, branching from the main portion as an elongation of a side constituting the main portion; and bonding, as mutually pressing to each other the base materials of the pair of the base materials, the pair of the base materials by the bonding material, by irradiating an electromagnetic wave to the bonding material while moving an irradiation position along the bonding material to melt the bonding material, and then hardening the melted bonding material.

Further features of the present invention will become apparent from the following description of exemplary embodiments with reference to the attached drawings.

### BRIEF DESCRIPTION OF THE DRAWINGS

FIG. 1 is a perspective view illustrating an image display apparatus according to the present invention.

FIG. 2 is a cross section diagram of a bonding portion, for describing a process flow according to the present invention.

FIGS. 3A, 3B, 3C and 3D are two-dimensional diagrams each illustrating the bonding portion according to the present invention.

FIGS. 4A and 4B are partial cross section diagrams of the bonding portion according to the present invention.

FIGS. 5A, 5B, 5C and 5D are diagrams for describing an effect of the present invention.

### DESCRIPTION OF THE EMBODIMENTS

Preferred embodiments of the present invention will now be described in detail in accordance with the accompanying drawings.

One aspect of the present invention is directed to a manufacturing method of an image display apparatus which comprises a first substrate having numerous electron-emitting devices, a second substrate positioned opposite to the first substrate and having a fluorescent film of displaying an image in response to irradiation of electrons emitted from the electron-emitting devices, and a frame member positioned between the first substrate and the second substrate to form a space between the first substrate and the second substrate. Here, this method comprises: a step of arranging a bonding material between a pair of base materials acting as the first substrate and the frame member or acting as the second substrate and the frame member, wherein the bonding material includes a main portion extending along one of the base materials acting as the frame member in a closed shape, and an additional portion, thinner than the main portion, branching from the main portion as an elongation of a side constituting the main portion; and a step of bonding, as mutually pressing to each other the base materials of the pair of the base materials, the pair of the base materials by the bonding material, by irradiating an electromagnetic wave to the main portion of the bonding material while moving an irradiation position along the bonding material to melt the main portion of the bonding material, and then hardening the melted main portion of the bonding material.

As described above, the crack in the base material generally occurs based on the corner or the end of the bonding material. In the above aspect of the present invention, since the additional portion which branches from the main portion as the elongation of the side constituting the main portion is provided, the additional portion is the end of the bonding material, i.e., the portion that the crack occurs easily. Although the shearing force strongly correlates with a compression stress or a tensile stress on the cross section which is orthogonal to the direction in which the bonding material extends and the cross section area, the additional portion is made thinner than the main portion, whereby the shearing force in the additional portion being the end of the bonding material does not increase easily. That is, since the shearing force at the position from which the crack occurs can be suppressed small, the occurrence of the crack can effectively be suppressed.

According to another aspect of the present invention, a base material bonding method comprises: a step of arranging, between a pair of base materials including a flat plate and a frame member, a bonding material which includes a main portion extending along the frame member in a closed shape, and an additional portion, thinner than the main portion, branching from the main portion as an elongation of a side constituting the main portion; and a step of bonding, as mutually pressing to each other the base materials of the pair of the base materials, the pair of the base materials by the bonding material, by irradiating an electromagnetic wave to the bonding material while moving an irradiation position along the bonding material to melt the bonding material, and then hardening the melted bonding material.

As described above, according to the present invention, it is possible to provide the manufacturing method of the image display apparatus and the bonding method of the base material, in which the stress applied from the bonding material to the base material due to heating and cooling of the bonding material and the base material can be reduced and the crack having a possibility of occurrence and widening from the corners of the bonding material can be easily suppressed.

Hereinafter, the embodiment of the present invention will be described. The present invention is preferably usable in an image display apparatus manufacturing method in which a vacuum container is used. In particular, the present invention is preferably applicable to an image display apparatus in which a fluorescent film and an electron accelerating electrode are formed on a face plate of a vacuum envelope and numerous electron-emitting devices are formed on a rear plate thereof. However, the present invention is widely applicable to a case of manufacturing an airtight container by properly bonding plural members and also widely applicable as a general bonding method of bonding base materials each other.

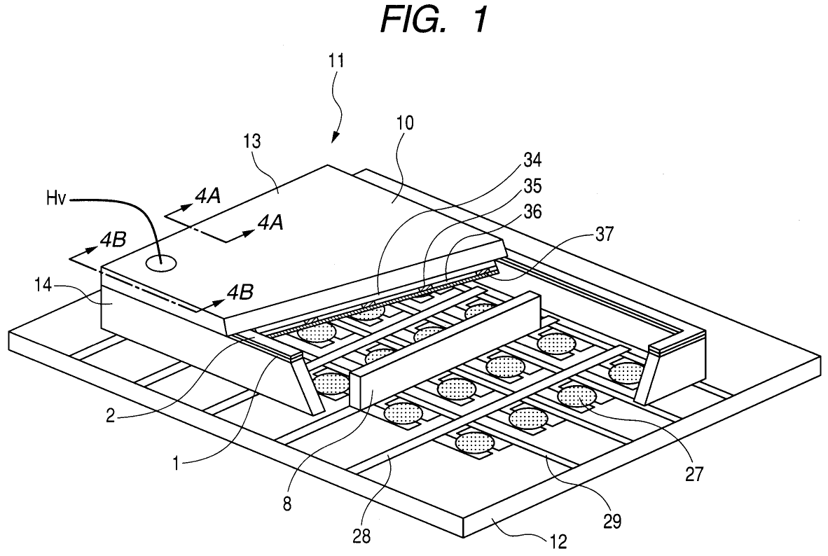

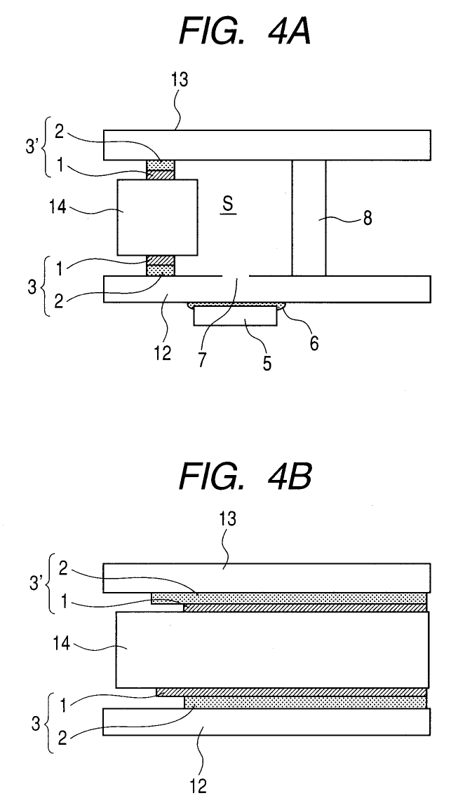

FIG. 1 is a partial cutaway perspective diagram illustrating an example of an image display apparatus to which the present invention is applied. That is, an image display apparatus 11 includes a first substrate (i.e., a rear plate) 12, a second substrate (i.e., a face plate) 13, and a frame member 14. The frame member 14 is positioned between the first substrate 12 and the second substrate 13 to form a closed space S (see FIG. 4A) between the first substrate 12 and the second substrate 13. More specifically, the first substrate 12 and the frame member 14 are bonded to each other through mutually opposite faces thereof, and the second substrate 13 and the frame member 14 are bonded to each other through mutually opposite faces thereof, whereby an envelope 10 having the closed internal space S is formed. Here, the internal space S of the envelope 10 is maintained with vacuum. In the frame member 14, the reverse face of the face fixed to the first substrate 12 is the face fixed to the second substrate 13. The first substrate 12 and the frame member 14 may be previously bonded to each other. Since each of the first substrate 12 and the second substrate 13 is made of the glass member, a warp after the bonding still decreases further, whereby it is possible to achieve the bonding in which safety improves and airtightness is excellent.

Further, on the first substrate 12, numerous electron-emitting devices 27 which emit electrons according to image signals are formed, and also wirings (X-direction wirings 28, and Y-direction wirings 29) which cause the respective electron-emitting devices 27 to operate according to the image signals are formed. On the second substrate 13 which is positioned opposite to the first substrate 12, a fluorescent film 34, which emits light in response to irradiation of the electrons emitted from the electron-emitting devices 27 to display an image, is provided. Also, on the second substrate 13, a black stripe 35 is provided. Here, the fluorescent film 34 and the black stripe 35 are alternately arranged. Further, a metal back 36, which is made by an Al thin film, is formed on the fluorescent film 34. The metal back 36, which has a function as an electrode for attracting the electrons, is supplied with potential from a high-voltage terminal Hv provided on the envelope 10. Further, a non-evaporable getter 37, which is made by a Ti thin film, is formed on the metal back 36.

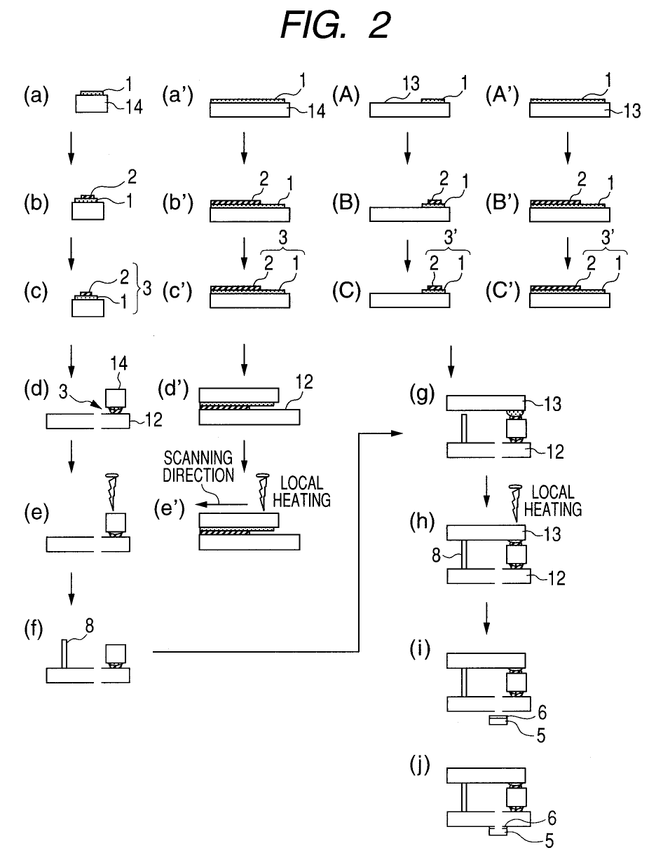

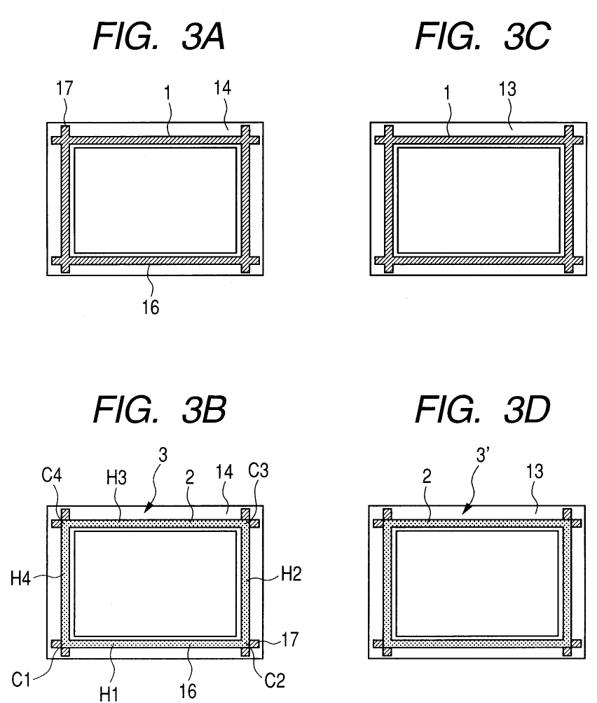

Subsequently, the present embodiment will be described concretely with reference to FIGS. 2, 3A, 3B, 3C, 3D, 4A and 4B. FIG. 2 is the cross section diagram for describing a process flow (bonding procedure) according to the present invention. In FIG. 2, the diagrams indicated by (a), (b) and the like are cross section diagrams viewed from a side of surface being orthogonal to the extending direction of the bonding material, and the diagrams indicated by (a′), (b′) and the like are cross section diagrams viewed from a side of surface being parallel to the extending direction of the bonding material. FIGS. 3A, 3B, 3C and 3D are the two-dimensional diagrams each illustrating the bonding portion. More specifically, FIG. 3A corresponds to (a) and (a′) in FIG. 2, FIG. 3B corresponds to (c) and (c′) in FIG. 2, FIG. 3C corresponds to (A) and (A′) in FIG. 2, and FIG. 3D corresponds to (C) and (C′) in FIG. 2. FIGS. 4A and 4B are cross section diagrams illustrating an example of the bonding portion. Here, FIG. 4A is the cross section diagram along the 4A-4A line in FIG. 1, and FIG. 4B is the cross section diagram along the 4B-4B line in FIG. 1. FIGS. 4A and 4B correspond to a state indicated by (g) in FIG. 2. However, a state before heating a bonding material 3 is illustrated in the drawing for convenience of description.

(Step S1: Step of Arranging Bonding Material to Frame Member)

Initially, a bonding material 3 which is made by a laminated body consisting of a first bonding material 1 and a second bonding material 2 is arranged on the face of one side of the frame member 14. More specifically, the first bonding material 1 is first formed in screen printing method so as to have desired width and thickness along the peripheral length, and then the formed material is dried at 120° C. ((a) and (a′) in FIG. 2, FIG. 3A). After then, the second bonding material 2 which is made of glass frit is formed, as well as the first bonding material 1, in screen printing so as to have desired width and thickness on the first bonding material 1 ((b) and (b′) in FIG. 2).

Further, to burn out organic matters, the bonding material is heated and baked at least once at 350° C. or more, whereby the bonding material 3 is formed ((c) and (c′) in FIG. 2, FIG. 3B). Here, as a method of applying the bonding material, a dispenser method, an offset printing method and the like can be used in addition to the screen printing method. By baking the bonding material at least once at the temperature of 350° C. or more, air bubbles generated from the bonding material when the bonding is performed are suppressed, whereby it is possible to achieve the bonding in which airtightness is more excellent. The bonding material 3 may be formed by the metal, of which a main component is Al, Ti, Sn, In, Ag, Cu, Au, Fe or Ni, or by the alloy thereof. Since an additional portion to be described later is easily formed, the bonding more excellent in airtightness can be achieved.

(Step S1′: Step of Arranging Bonding Material to Second Substrate)

In the same manner as that in the step S1, a bonding material 3′ which is made by a laminated body consisting of the first bonding material 1 and the second bonding material 2 is arranged. More specifically, on the face of the second substrate 13 opposite to the frame member 14, the first bonding material 1 is first formed in screen printing so as to have desired width and thickness along the peripheral length, and then the formed material is dried at 120° C. ((A) and (A′) in FIG. 2, FIG. 3C). After then, the second bonding material 2 is likewise formed in screen printing so as to have desired width and thickness on the first bonding material 1 ((B) and (B′) in FIG. 2). Further, to burn out organic matters, the bonding material is heated and baked at 350° C. or more, whereby the bonding material 3′ is formed ((C) and (C′) in FIG. 2, FIG. 3D).

Here, the bonding material 3, which has a curb-like shape as illustrated in FIG. 3B, includes a main portion 16 extending along the frame member 14 in a closed rectangular form or a frame form and an additional portion(s) 17 which branches from the main portion 16. The additional portions 17 are constituted as elongations of respective sides H1 to H4, which constitute the main portion 16, and extend to the two directions parallel to the respective sides (for example, in case of a corner portion C1, sides H1 and H4) of forming corner portions from the respective corners C1 to C4 of the main portion 16. The first bonding material 1 includes the frame-form main portion 16 and the additional portions 17 as illustrated in FIG. 3A, and the second bonding material 2 includes only the frame-form main portion 16 as illustrated in FIG. 3B. As a result, the overall configuration of the bonding material 3 is determined by the configuration of the first bonding material 1, and the main portion 16 is formed thicker than the additional portion 17 and the additional portion 17 is formed thinner than the main portion 16. In the present embodiment, a thickness of the additional portion 17 is constant. The additional portions 17 may not be completely parallel to the respective sides H1 to H4, which constitute the main portion 16, and the lengths of the additional portions 17 may be different from each other. As to the additional portions 17, only the one additional portion may be formed in each of the corner portions C1 to C4, or the additional portion may not be formed in a part of the corner portions. The bonding material 3′ also has the same constitution as that of the bonding material 3 as indicated in FIGS. 3C and 3D.

In the present embodiment, although the bonding material 3 is formed by the two-stage constitution composed of the first bonding material 1 and the second bonding material 2, and if the bonding material 3 is provided in a curb-like shape by intersecting four pieces of linear bonding materials having thin both ends each other, formation of the bonding material 3 is sufficient by a single process for each of the sides. This kind of method can be performed by changing, for example, printing speed or applying speed.

(Step S2: Step of Bonding First Substrate and Frame)

Subsequently, the bonding material 3 is put on the first substrate 12, and the frame member 14 is located at a predetermined position on the first substrate 12 ((d) and (d′) in FIG. 2). In this case, only the main portion 16 contacts with the first substrate 12, and the additional portion 17 having thin thickness does not contact with the first substrate 12. Then, light emitted from a halogen lamp or a laser beam output device is condensed and irradiated to the main portion 16 of the bonding material 3 while applying the pressure from the side of the frame member 14, whereby the main portion 16 of the bonding material 3 is locally heated. Thus, the main portion 16 of the bonding material 3 is melted, and then hardened, whereby the first substrate 12 and the frame member 14 are bonded to each other ((e) and (e′) in FIG. 2). The light is scanned along the frame-form main portion 16, and the first substrate 12 and the frame member 14 are sequentially bonded in accordance with the scanning. Here, the light to be used is not specifically limited, if it is an electromagnetic wave having sufficient energy for enabling to melt the bonding material 3. Although the light is not irradiated to the additional portion 17 of the bonding material 3, it may well be that the bonding material 3 is melted by the heat-transfer from the main portion 16 and then hardened depending on the size or the heat capacity of the additional portion 17. However, since the additional portion 17 does not contact with the first substrate 12, the additional portion 17 never contribute to the bonding between the first substrate 12 and the frame member 14.

(Step S3: Step of Bonding Frame Member to which First Substrate has been Bonded to Second Substrate)

Next, a spacer 8 is arranged on the wirings 28 and 29 of the first substrate 12 (refer to (f) in FIG. 2). Thereafter, the second substrate 13 is arranged on the other surface, which is not bonded with the first substrate 12, of the frame member 14 after aligning with the first substrate 12 (refer to (g) in FIG. 2). In this case, only the main portion 16 contacts with the frame member 14, and the additional portion 17 having thin thickness does not contact with the frame member 14. Then, the light emitted from the halogen lamp or the laser beam output device is condensed and irradiated to the main portion 16 of the bonding material 3′ while the bonding material 3′ is being pressed from a side of the second substrate 13, whereby the main portion 16 of the bonding material 3′ is locally heated. Here, such pressing may be performed by mechanically adding a load or adding the atmospheric pressure while decreasing pressure. Thus, the bonding material 3′ is melted, and then hardened, whereby the second substrate 13 and the frame member 14 are bonded to each other ((h) in FIG. 2). At that time, the spacer 8 and the second substrate 13 are in contact with each other, whereby an interval between the first substrate 12 and the second substrate 13 is maintained constantly. Also, in this step, since the additional portion 17 does not contact with the frame member 14, the additional portion 17 never contribute to the bonding between the second substrate 13 and the frame member 14.

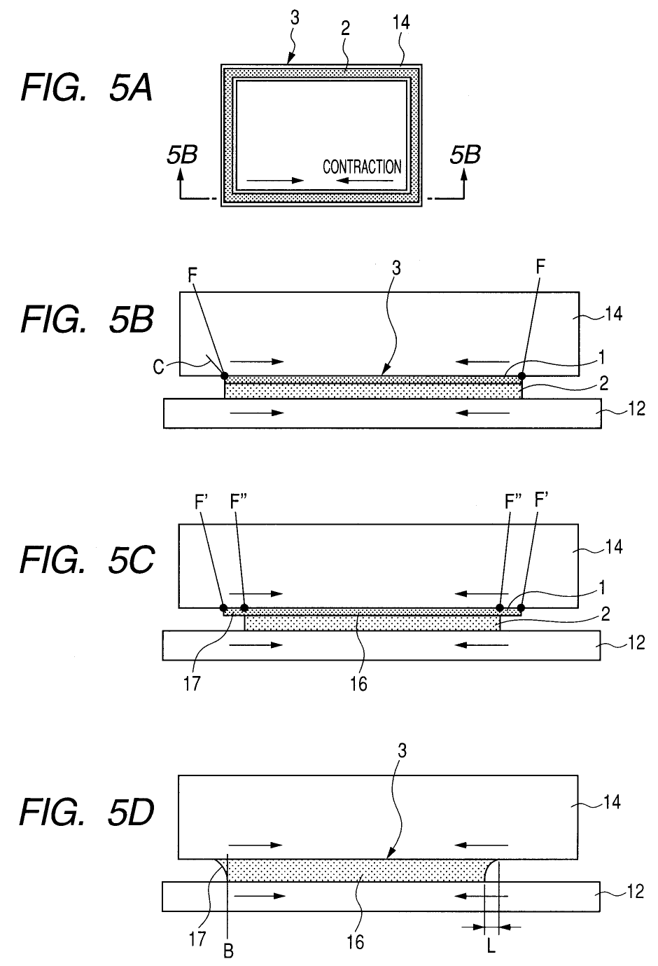

FIGS. 5A, 5B, 5C and 5D are conceptual diagrams indicating an effect of the bonding method according to the present embodiment. As a comparing example, the constitution that the bonding material 3 does not have the additional portion 17 as illustrated in FIGS. 5A and 5B is initially considered. FIG. 5B is a cross section diagram along the 5B-5B line in FIG. 5A. Both the first bonding material 1 and the second bonding material 2 have a frame-like shape, and edges of the first bonding material 1 and the second bonding material 2 are terminated at the same position on each of the sides as illustrated in FIG. 5B. When the bonding material 3 is cooled down after terminating the bonding process, the bonding material 3 contracts toward the inside as indicated by the arrows in FIG. 5A and FIG. 5B. In this case, the bonding material 3 contracts around the central portion, and a contraction amount (moving amount) of both ends F represents the maximum value. Therefore, shearing force applied to the frame member 14 from the bonding portion becomes a maximum level at the both ends F. The inward shearing force is applied to the frame member 14 in such a condition of being drawn by the bonding material 3 at a portion which contacts with the bonding material 3. However, since shearing force is not applied at a portion which does not contacts with the bonding material, the particular large tensile force is applied at portions of the both ends F. According to the above facts, generally, the both ends F of the bonding portion become such regions where the crack C is most easily generated.

In contrast, when the additional portion 17 is provided at the first bonding material 1 as illustrated in FIG. 5C, since the bonding material 3 contracts on the basis of the entire length including the additional portion 17, a tip portion F′ of the additional portion 17 indicates the maximum contraction amount (moved amount). However, since the shearing force is proportional to a cross-sectional area of the bonding material, the shearing force to be generated at the additional portion 17 becomes a small force practically. Meanwhile, the shearing force to be generated at a connecting portion F″ of the main portion and the additional portion 17 is equivalent to the shearing force at portions of the both ends F of the bonding material in the above-described comparing example. However, since the vicinity of the connecting portion F″ is covered by the bonding material 3, the large tensile force is not applied to the frame member 14. According to the above-described reason, a possibility of generating the crack in the frame member 14 can be decreased.

Alternatively, as apparent from the above-described description, the additional portion forms a part of the bonding material, and the additional portion is only necessary to be formed in such the thickness less than that of the main portion. Therefore, the bonding portion is not required to be the two-stage constitution composed of the first bonding portion and the second bonding portion as described above. As illustrated in FIG. 5D, it is needless to say that the same effect can be obtained even if the bonding portion is integrally formed and the end portions thereof is formed into a taper-like shape, that is, formed into such a shape that the additional portion 17 gradually reduces its thickness heading to the direction of separating from the main portion 16 starting from a branch point B branching from the main portion 16. When such the shape is adopted, for example, in a case that thickness of the bonding material is 10 μm, a sufficient effect is proved even if the length L of the additional portion is about 10 μm equivalent to the thickness of the bonding material.

In the present embodiment, although the bonding material 3 is provided on the frame member 14 and the bonding material 3′ is provided on the second substrate 13, the base material, on which the bonding material is provided, is not limited to this case. The bonding material 3 can be provided on the first substrate 12 and the bonding material 3′ can be provided on the frame member 14. In conclusion, it is only necessary to provide each bonding material so as to position between a pair of base materials to serve as the first substrate and the frame member and a pair of base materials to serve as the second substrate and the frame member.

(Step S4: Baking and Sealing Step)

To increase a degree of vacuum of the internal space of the envelope 10, baking is performed at a predetermined temperature after the heating process. More specifically, the envelope 10 is set up in a vacuum chamber (not illustrated), and the degree of vacuum in the chamber is decreased to 10⁻³ Pa or so, while vacuum-exhausting the inside of the envelope 10 through an exhaust hole 7 ((i) in FIG. 2). After then, the envelope 10 is wholly heated, and the non-evaporable getter 37 is activated. Further, the exhaust hole 7 is sealed by a sealing material 6 and a sealing cover 5, and the image display apparatus 11 is thus formed ((j) in FIG. 2). As a material of the sealing cover 5, it is desirable to use the material same as that of the first substrate 12. However, it is also possible to use metal or alloy such as Al, Ti, Ni or the like which is not melted in vacuum baking. Further, it is possible to have the same effect even if the heating process ((h) in FIG. 2) is performed after the baking process ((i) in FIG. 2).

To determine the bonding material and the bonding method which are applicable to the image display apparatus, it is necessary to consider the following matters:

(1) heat resistance in the in-vacuum baking (high vacuum forming) process;
(2) maintenance of high vacuum (vacuum leakage minimum, gas permeableness minimum);
(3) securement of adhesiveness to the glass member;
(4) securement of a low outgassing (high vacuum maintaining) characteristic; and
(5) less warp of the image display apparatus after the bonding.

The bonding method according to the present embodiment satisfies all of such conditions.

The above-described embodiment can be generalized described as follows. An arbitrary pair of base materials to be bonded to each other, such as a pair of the first substrate and the frame member or a pair of the second substrate and the frame member, is assumed. Here, as a pair of base materials, a flat plate and the frame member are assumed. A step of bonding the flat plate to the frame member includes the following steps.

(1) The bonding material, which has a main portion extending along the frame member in a closed form and the additional portion, of which thickness is thinner than that of the main portion, branching from the main portion as an elongation of the side which constitutes the main portion, is arranged between a pair of base materials consisted of the flat plate and the frame member.

(2) An electromagnetic wave is irradiated to the bonding material while moving an irradiation position along the bonding material while pressing a pair of base materials to each other and the bonding material is melted, and then hardened, whereby a pair of the base materials is bonded by the boning material.

Hereinafter, the present invention will be described in detail by taking concrete examples.

### Example 1

The image display apparatus 11, which uses the bonding material and the bonding method of this example, has the same constitution as that of the apparatus schematically illustrated in FIG. 1. On the first substrate 12, plural electron-emitting devices 27 are arranged and the wirings are formed. The first substrate 12 and the frame member 14 are bonded to each other by the first and second bonding materials 1 and 2, and also the second substrate 13 and the frame member 14 are bonded to each other by the first and second bonding materials 1 and 2. The materials of the first substrate 12, the second substrate 13 and the frame member 14 are to be the same material (PD200 (available from ASAHI GLASS CO., LTD.)) each other.

In the image display apparatus of this example, the plural (240 rows×720 columns) surface conduction electron-emitting devices 27 are formed on the first substrate 12. The surface conduction electron-emitting devices 27 are electrically connected to the X-direction wirings (also called upper wirings) 28 and the Y-direction wirings (also called lower wirings) 29, whereby simple matrix wirings are provided. The fluorescent film 34 consisting of striped red, green and blue phosphors (not illustrated) and the black stripe 35 are alternately arranged on the second substrate 13. Further, on the fluorescent film 34, the metal back 36 made by an Al thin film is formed by a sputtering method at the thickness 0.1 μm, and a Ti film formed at the thickness 0.1 μm by an electron beam vacuum vapor deposition method is provided as the non-evaporable getter 37.

Hereinafter, the bonding method of the image display apparatus in this example will be described with reference to FIGS. 1, 2 and 3A to 3D. In this example, the glass frit is used as the bonding material 3.

(Step a) A paste (the first bonding material 1) obtained by compounding terpineol, Elvacite™, and Bi-based lead-free glass frit of BAS115 base (available from ASAHI GLASS CO., LTD.: the thermal expansion coefficient α=75×10⁻⁷/° C.)) acting as the base material of the first bonding material 1 was prepared. The paste was formed in a curb-like shape to have the width of 1 mm and the thickness of 10 μm by the screen printing method, and then dried at 120° C. ((a) and (a′) in FIG. 2, FIG. 3A).

(Step b) A paste (the second bonding material 2), which is the same as the paste used in the (step a) was prepared. This paste was formed to have the width of 1 mm and the thickness of 10 μm only on the main portion of the dried first bonding material 1 by the screen printing method similar to a case of the first bonding material 1 ((b) and (b′) in FIG. 2). Herewith, the paste having the main portion and the additional portion thinner than the main portion could be formed.

(Step c) To burn out the organic matters, the bonding material was heated and baked at 480° C., whereby the bonding material 3 was formed ((c) and (c′) in FIG. 2, FIG. 3B).

(Step A) A paste (the second bonding material 2) obtained by compounding terpineol, Elvacite™, and Bi-based lead-free glass frit of BAS115 base (available from ASAHI GLASS CO., LTD.: the thermal expansion coefficient α=75×10⁻⁷/° C.)) acting as the base material of the second bonding material 2 was prepared. This paste was formed to have the width of 1 mm and the thickness of 10 μm along the peripheral length on a surface of the second substrate 13 opposite to the frame member 14 by the screen printing method, and then dried at 120° C. ((A) and (A′) in FIG. 2, FIG. 3C).

(Step B) A paste, which is the same as the paste used in the (step A) was prepared. This paste was formed to have the width of 1 mm and the thickness of 10 μm on the dried first bonding material 1 by the screen printing method similar to a case of the second bonding material 2 ((B) and (B′) in FIG. 2). Herewith, the paste having the main portion and the additional portion thinner than the main portion could be formed.

(Step C) To burn out the organic matters, the bonding material was heated and baked at 480° C., whereby the bonding material 3′ was formed ((C) and (C′) in FIG. 2, FIG. 3D).

(Step d) The frame member 14 was located on the first substrate 12 at a predetermined position of the first substrate 12 so that the main portion 16 of the formed bonding material 3 contacts with first substrate 12 ((d) in FIG. 2).

(Step e) A semiconductor laser beam having the wavelength 980 nm, the power 130 W and the effective diameter 1 mm was irradiated, as scanning at the speed 300 mm/S, to the bonding material 3 while pressing the bonding material from the side of the frame member 14, whereby the bonding material 3 was locally heated. Thus, the bonding material was melted, and then hardened, whereby the first substrate 12 and the frame member 14 were bonded to each other ((e) in FIG. 2).

(Step f) The spacer 8 was arranged on the wirings 28 and 29 of the first substrate 12 ((f) in FIG. 2).

(Step g) The bonding material 3′ formed on the second substrate 13 was brought into contact with the other face of the frame member 14 to which the first substrate 12 was not bonded, and the second substrate 13 was arranged through alignment on the first substrate 12 ((g) in FIG. 2).

(Step h) A semiconductor laser beam having the wavelength 980 nm, the power 130 W and the effective diameter 1 mm was irradiated, as scanning at the speed 300 mm/S, to the bonding material 3′ while pressing the bonding material from the side of the second substrate 13, whereby the bonding material 3′ was locally heated. Thus, the bonding material 3′ was melted, and then hardened, whereby the frame member 14 bonded to the second substrate 13 was bonded to the first substrate 12 ((h) in FIG. 2). The spacer 8 and the second substrate 13 were in contact with each other, whereby the interval between the first substrate 12 and the second substrate 13 was maintained constantly, and the envelope 10 was formed.

(Steps i, j) The envelope 10 was set up in the vacuum chamber (not illustrated), and the degree of vacuum in the chamber was set to 10⁻³ Pa or so, while vacuum-exhausting the inside of the envelope 10 through the exhaust hole 7. The envelope 10 was wholly heated up to 350° C., and the non-evaporable getter 37 was activated. After then, the exhaust hole 7 was sealed by the sealing material 6 made by In and the sealing cover 5 made by a glass substrate, whereby the image display apparatus 11 was formed.

In the image display apparatus in FIG. 1 of the this example bonded as above, the bonding material having the main portion and the additional portion thinner than the main portion is formed in the steps a and b (steps A and B). Accordingly, the laser bonding, which can suppress the generation of crack at the bonding portion induced by the thermal contraction, improves the safety and is excellent in airtightness could be obtained.

In this example, an example of arranging the non-evaporable getter 37 on the second substrate 13 was described. However, the non-evaporable getter may be arranged on the first substrate 12.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-211714, filed Sep. 14, 2009, which is hereby incorporated by reference herein in its entirety.

What is claimed is:

1. A manufacturing method of an image display apparatus which comprises a first substrate having numerous electron-emitting devices, a second substrate positioned opposite to the first substrate and having a fluorescent film of displaying an image in response to irradiation of electrons emitted from the electron-emitting devices, and a frame member positioned between the first substrate and the second substrate to form a space between the first substrate and the second substrate, the method comprising:
arranging a bonding material between a pair of base materials acting as the first substrate and the frame member or acting as the second substrate and the frame member, wherein the bonding material includes a main portion extending along one of the base materials acting as the frame member in a closed shape, and an additional portion, thinner than the main portion, branching from the main portion as an elongation of a side constituting the main portion; and
bonding, as mutually pressing to each other the base materials of the pair of the base materials, the pair of the base materials by the bonding material, by irradiating an electromagnetic wave to the main portion of the bonding material while moving an irradiation position along the bonding material to melt the main portion of the bonding material, and then hardening the melted main portion of the bonding material.

2. The manufacturing method according to claim 1, wherein a thickness of the additional portion gradually decreases from a branch point between the additional portion and the main portion.

3. The manufacturing method according to claim 1, wherein the additional portion has a certain thickness which is smaller than a thickness of the main portion.

4. The manufacturing method according to claim 1, wherein
the main portion has a rectangular shape, and
the additional portion extends, from each corner portion of the main portion, toward two directions in parallel with respective sides forming the corner portion.

5. The manufacturing method according to claim 1, wherein the arranging of the bonding material further comprises providing a curb-like bonding material on a face of one of the base materials opposite to the other of the base materials, and providing another bonding material at a frame-like portion of the curb-like bonding material.

6. The manufacturing method according to claim 1, wherein the arranging of the bonding material further comprises providing, on a face of one of the base materials opposite to the other of the base materials, four linear bonding materials each having thin both ends as mutually crossing the bonding materials to make a curb-like shape.

7. The manufacturing method according to claim 1, wherein the bonding material includes glass frit baked at least once at a temperature of 350° C. or more.

8. The manufacturing method according to claim 1, wherein the bonding material includes metal or alloy which uses Al, Ti, Sn, In, Ag, Cu, Au, Fe or Ni as a main component.

9. A base material bonding method comprising:
arranging, between a pair of base materials including a flat plate and a frame member, a bonding material which includes a main portion extending along the frame member in a closed shape, and an additional portion, thinner than the main portion, branching from the main portion as an elongation of a side constituting the main portion; and
bonding, as mutually pressing to each other the base materials of the pair of the base materials, the pair of the base materials by the bonding material, by irradiating an electromagnetic wave to the bonding material while moving an irradiation position along the bonding material to melt the bonding material, and then hardening the melted bonding material.
